(19) United States
(12) Patent Application Publication
(10) Pub. No.: US 2004/0089176 A1
(43) Pub. Date: May 13, 2004

(54) Drive system for a printing group

(76) Inventor: Bernd Kurt Masuch, Kurnach (DE)

Correspondence Address: Douglas R Hanscom, Jones Tullar & Cooper, P O Box 2266, Eads Station, Arlington, VA, 22202, US

(21) Appl. No.: 10/466,762

(22) PCT Filed: Feb. 5, 2002
(86) PCT No.: PCT/DE02/00416

(30) Foreign Application Priority Data
Mar. 26, 2001 (DE) 101 14 801.1
Mar. 26, 2001 (DE) 101 14 806.2

(51) Int. Cl. B41F 13/008

(52) U.S. Cl. 101/216

(57) ABSTRACT

The invention relates to a drive system for a printing group comprising a form cylinder (01), an inking unit allocated to said form cylinder and a second cylinder (02) that co-operates with the form cylinder, said second cylinder forming a printing point with a third cylinder (05) that is not connected by positive-fit in a driven manner to the printing group. The form cylinder can be driven by a drive motor (M). The second cylinder (02) can be driven by a drive connection (06, 08) originating from the form cylinder and the inking unit allocated to the form cylinder is driven by the second cylinder using the same drive motor.

The invention relates to a drive system for a printing group in accordance with the preamble of claim 1.

A printing group with a forme and a transfer cylinder driven as a pair is known from DE 44 30 693 A1, wherein the forme cylinder is driven and transfers the driving force to the transfer cylinder via spur wheels. In one embodiment, a journal of the forme cylinder embodied as a rotor can be axially displaced in the stator for adjusting the lateral register.

EP 0 644 048 B1 discloses cylinders driven in pairs. The possibility of coupling an assigned inking system to the drive combination of the pair is mentioned. In a schematic representation, the transfer cylinder is driven by the drive motor, and the driving force is transferred from the transfer cylinder to the forme cylinder and from the forme cylinder to the inking system.

In DE 196 03 663 A1 a forme cylinder and a transfer cylinder acting together with it can be driven in parallel by means of a motor. The forme cylinder can be axially adjusted by means of a gear, and can be displaced in the circumferential direction in respect to the transfer cylinder by means of helical teeth. An inking system assigned to the forme cylinder can be driven by means of a spur wheel arranged on the journal of the forme cylinder.

DE 20 14 070 A1 discloses a drive system of a rotary printing press, wherein a cylinder pair of forme and transfer cylinders is driven from the forme cylinder. In order to perform an unequivocal driven connection in the friction drive of two transfer cylinders acting together, the two transfer cylinders are connected non-positively, but releasably, with each other.

The driving of a four-cylinder printing unit by means of a drive system acting on the respective forme cylinder is known from DE 20 14 753 A1, wherein at least one of the respective transfer cylinders driven by the respective forme cylinder can be charged with a braking force for preventing tooth flank shifts.

DE 25 53 768 B1 provides a selectively independent driving of the forme cylinder and the inking system, in that the drive combination of forme and transfer cylinder has a releasable coupling. In a possible embodiment, a transfer cylinder and an inking system of a printing group can be driven by a drive motor acting on the forme cylinder.

DE 40 01 626 A1 discloses a drive train, wherein the driving force is transferred parallel from a counter-pressure cylinder to an inking system and to a transfer cylinder, and from there to a forme cylinder. In this way interferences are re-transferred to a lesser degree from the inking system the forme cylinder.

The object of the invention is based on providing a drive system for a printing group.

In accordance with the invention, this object is attained by means of the characteristics of claim 1.

The advantages to be gained by means of the invention consist in particular in that, because of the drive system at the forme cylinder, no movement of the drive motor need to occur when the transfer cylinder is placed into the print-on and print-off position, such as would be the case, for example, in connection with the drive directly from the transfer cylinder. Also, a compromise based on such pivot movements of the transfer cylinder in regard to the position of the drive motor and the meshing of the gear wheels when the drive motor is arranged on the transfer cylinder, can be omitted when the forme cylinder is driven. Otherwise this could lead to tooth breaks or to a reduction of the printing quality because of the play in the drive system.

The drive system of the printing group is independent of the drive system of a further cylinder or printing group which, together with the printing group, constitutes a printing position, and preferably does not have any mechanical, in particular positive drive connection with the latter.

If only the inking system and the transfer cylinder are designed for making and releasing the contact, a rigid connection of the drive motor with a frame can be provided.

A pinion of the drive motor with straight teeth can transfer power directly to a straight-toothed pinion wheel at the journal of the forme cylinder, provided the straight-toothed embodiment assures the strength values, for example extent of coverage and breaking resistance.

In another form of embodiment the drive motor can be arranged directly axially in relation to the forme cylinder. For making possible an axial movement of the forme cylinder for the purpose of adjusting the lateral register, a coupling, which is flexible in the axial direction, can be arranged between the journal and the drive motor. The embodiment of the drive motor with a planetary gear arranged between the rotor and the journal of the cylinder is advantageous in respect to advantageous ranges of the numbers of revolutions, in particular in the start-up phase.

In those cases where strength requires helical teeth for force transfer, an arrangement is advantageous, wherein the pinion of the drive motor does not transfer power directly to the spur wheel of the forme cylinder. In this case, a displacement of the circumferential register would take place simultaneously with an axial movement of the forme cylinder, unless additional measures have been taken. These measures would be, for example, a simultaneous correction via the control device, which requires outlay for regulation, or a permissible relative movement of the journal in respect to the spur wheel of the forme cylinder which, however, requires guide devices which cannot, or only with a large outlay, be produced free of play in the circumferential direction. A coupling which is flexible in the axial direction could again be employed in an advantageous manner for the axial mobility of the forme cylinder.

It is advantageous in connection with the mentioned embodiments of the drive system of the forme cylinder, if an inking system assigned to the forme cylinder and, if provided, also a dampening system, are driven by the same drive motor. This saves expense and assures synchronization, provided the correct transmission ratios are employed.

An unequivocal flow of moment from the drive motor to the various units to be driven is particularly advantageous for the exact roll-off of the cylinders and rollers during production. In an advantageous embodiment this is achieved in that driving takes place from the forme cylinder to the transfer cylinder, and from the transfer cylinder to the inking system, i.e. serially. In this connection an embodiment is particularly economical wherein driving takes place from the transfer cylinder to the inking system via a gear wheel, which is rotatably seated on the journal of the forme cylinder.

A coupling between the drive motor and the forme cylinder, which is flexible in the axial direction, is embodied in an advantageous manner as a shaft coupling, which is flexible, or yielding, in the axial direction, for example an expansion or compensation coupling. The employment of a non-shiftable positive shaft coupling is particularly advantageous which, in contrast to other positive couplings, is almost free of play in the circumferential direction, without requiring a large production outlay, and which simultaneously allows an axial length change of the coupling, i.e. an axial movement of the forme cylinder. The coupling is embodied to be positive in the axial direction, but flexible or yielding in length, for example by an elastic and reversible deformation.

The steps for an unequivocal moment flow direction and, if a coupling is required, for the embodiment of the latter as a torsion-proof, but longitudinally adjustable coupling, are used for minimizing the play in the drive system, and for an improvement of the print quality because of this.

Exemplary embodiments of the invention are represented in the drawings and will be described in greater detail in what follows.

Shown are in:

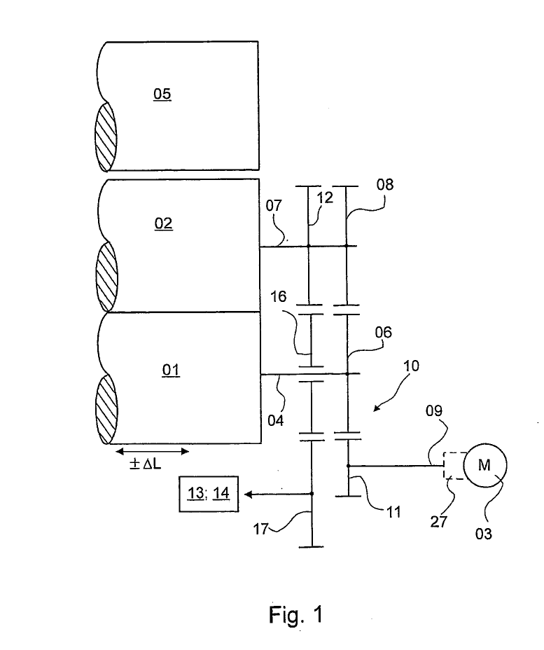

FIG. 1, a first exemplary embodiment of the drive system of a printing group,

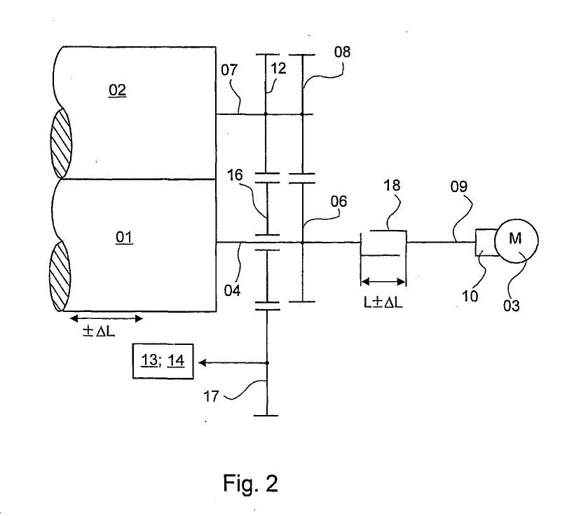

FIG. 2, a second exemplary embodiment of the drive system of a printing group,

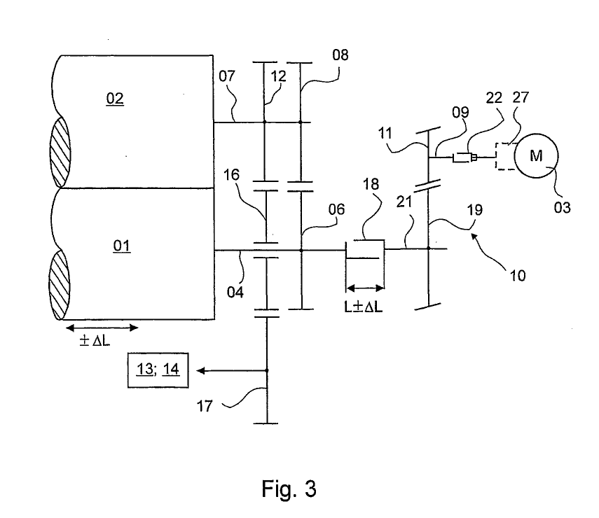

FIG. 3, a third exemplary embodiment of the drive system of a printing group,

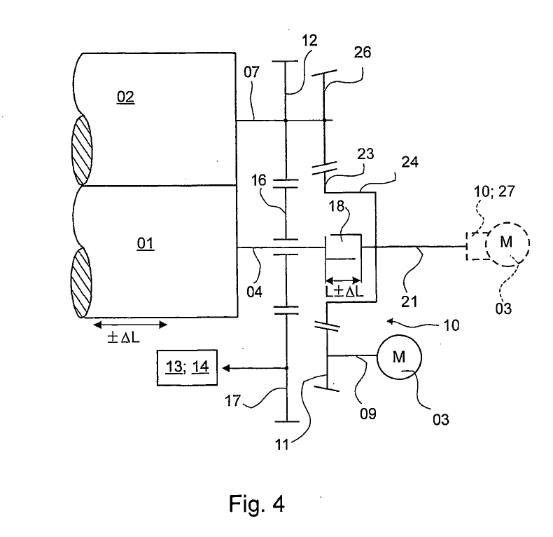

FIG. 4, a fourth exemplary embodiment of the drive system of a printing group.

A printing group of a printing press has a first cylinder 01, for example a forme cylinder 01, and a second cylinder 02, for example a transfer cylinder 02. The two cylinders 01, 02 can be driven together by means of a drive motor 03, which is in operative connection with the forme cylinder 01, where power is transferred from the forme cylinder 01 to the transfer cylinder 02 by a drive connector. During printing, the transfer cylinder 02 acts together and forms a printing position with a third cylinder 05, only shown in FIG. 1, for example a second transfer cylinder 05 of a cooperating printing group, or with a counter-pressure cylinder 05, for example a satellite cylinder 05, which does not convey ink. The drive system of the third cylinder 05, or of the cooperating second printing group, is not in a positive drive connection with the printing group driven by the drive motor 03.

As represented in FIG. 1, a gear wheel 06, which is arranged, fixed against relative rotation, on a journal 04 of the forme cylinder 01, together with a gear wheel 08, which is arranged, fixed against relative rotation, on a journal 07 of the transfer cylinder 02, constitutes the drive connection between the forme cylinder 01 and the transfer cylinder 02.

In a first exemplary embodiment (FIG. 1), a pinion 11, arranged on a shaft 09 of the drive motor 03, acts directly on the gear wheel 06 arranged on the journal 04 of the forme cylinder 01. The gear arrangement 06, 11 from the drive motor 03 to the journal 04, or the gear wheel 06, can also be constituted by means of a differently embodied gear, for example via further gear wheels, toothed belts, bevel wheels, or in any other way. However, for assuring an axial displaceability (indicated by a two-headed arrow in FIG. 1) of the forme cylinder 01, the pinion 11, as well as the gear wheels 06, 08 are embodied in the example with straight teeth. The width of the pinion 11 and the gear wheels 06, 08 has been selected to be such that in case of an axial displacement of the forme cylinder 01 by an amount±Delta L a sufficient coverage of the teeth is assured.

A further gear wheel 12 is arranged, fixed against relative rotation, on the journal 07 of the transfer cylinder 02, from which an inking system 13 assigned to the forme cylinder 01 and, if provided a dampening unit 14, are driven (the inking system 13 and the dampening unit 14 are only represented as reference numerals in the drawing figures).

In the present example, the gear wheel 12 drives a gear wheel 16, rotatably arranged on the journal 04 of the forme cylinder 01, which in turn meshes with a gear wheel 17 of a drive system, not further represented, of the inking system 13 (and, if provided, of the dampening unit 14).

The moment flow of the drive system from the drive motor 03 via the forme cylinder 01 to the transfer cylinder 02, and from there to the inking system 13 (and, if provided, to the dampening unit 14) takes place unequivocally, because it is serial. A shift of the tooth flanks during load changes (bringing the cylinders 01, 02, the inking system 13, the dampening unit 14 in or out of contact, or changes in the conditions) is avoided to a large extent, which results in reduced wear and in particular in better printing results.

In a second exemplary embodiment (FIG. 2), the shaft 09 of the drive motor 03 is arranged coaxially in respect to an axis of rotation of the forme cylinder 01 and is connected in a torsion-proof manner with the journal 04 of the forme cylinder 01. In an advantageous embodiment, a coupling, which can be changed in its length L in the radial direction by the amount ±Delta L, for example a coupling 18, is arranged between the drive motor 03 and the journal 04. In particular, it can be an expansion coupling 18, a coupling 18 which is elastic in the axial direction, or a non-shiftable shaft coupling 18 which is, however positively connected in the axial direction, but is resilient. In this case the end of the coupling 18 facing away from the forme cylinder 01 is arranged fixed in place in relation to an axial direction. With the arrangement of the coupling 18, the associated drive motor 03 can therefore be arranged fixed in place, or to the frame, in case of an axial displacement of the forme cylinder 01. The amount Delta L of an axial displacement of the forme cylinder 01 preferably lies between 0 and ±4 mm, in particular between 0 and ±2.5 mm, and is picked up by the change of the length L of the coupling 18 by this amount ±Delta L.

A particularly suitable coupling 18 is a flexibly resilient all-metal coupling, also called a diaphragm or ring coupling.

A third exemplary embodiment (FIG. 3) differs from the exemplary embodiment of FIG. 2 in that the drive motor 03 is not arranged coaxially in respect to the forme cylinder 01. A pinion 11 connected with the shaft 09 of the drive motor 03 drives a gear wheel 19 which is connected, fixed against relative rotation, via a shaft 21 or a journal 21 with the side of the coupling 18 facing away from the forme cylinder 01. This embodiment is particularly advantageous if, because of high loads, the strength values, for example the extent of coverage and breaking resistance, require helical teeth on the pinion 11 and the gear wheel 19. The two cooperating gear wheels 06, 08 on the journals 04, 07 of the cylinders 01, 02 are embodied in an advantageous manner with straight teeth, because in this way a relative axial movement toward each other is made possible without a compensation in the circumferential register being required. The inking system 13 (and possibly the dampening unit 14) can be driven from the transfer cylinder 02, corresponding to the second exemplary embodiment.

For improved disassembly, or for maintenance, a further coupling 22, for example a claw coupling 22, or a coupling 22 like the coupling 18, can be arranged between the drive motor 03 and the pinion 11.

In a fourth exemplary embodiment (FIG. 4), the power transfer from the forme cylinder 01 to the transfer cylinder 02 does not occur on the side of the coupling 18 facing the forme cylinder 01, but on the side of the coupling 18 which is not movable in the axial direction. For this purpose, the drive connection between the forme cylinder 01 and the transfer cylinder 02 is not arranged between the coupling 18, whose length L can be changed in the axial direction, and the forme cylinder 01, but on the stationary side of the coupling 18 facing away from the forme cylinder 01.

For saving space and for shortening the distance from the drive system of the forme cylinder 01 to the latter, a gear wheel 23 can be arranged, for example, on a bushing 24 enclosing the coupling 18 and can be connected with the side of the coupling 18 facing away from the forme cylinder 01. On one side, this gear wheel 23 meshes with a gear wheel 26 which is connected, fixed against relative rotation, with the journal 07 of the transfer cylinder 02, and with the pinion 11. In comparison with FIG. 3, a drive level can be saved, and driving of the two cylinders 01, 02 from the drive motor 03 can take place via helical teeth. The drive connection formed by the gear wheels 23 and 26 is not located on the side of the coupling 18 facing the forme cylinder 01, which is to be moved axially, but on the side which is fixed in place in respect to an axial movement. In this case it is advantageous if the distances of the gear wheels 23, 26 from the respective cylinder 01, 02 are as short as possible. As indicated in FIG. 4, driving can also take place coaxially directly to the shaft 21, but in particular via a gear, for example a reduction gear.

For all exemplary embodiments, in particular for the embodiment variations (FIGS. 2 and 4) with the drive motor 03 arranged coaxially with the forme cylinder 01, a reduction gear 10, 27, for example a planetary gear 10, 27, of which only a portion is shown, can be arranged on the drive motor 03, or between the drive motor 03 and the drive connection between the forme cylinder 01 and the transfer cylinder 02 in an advantageous further development. This can be, for example, an adapter gear, which is connected with the drive motor 03 and reduces the number of revolutions.

The drive connections between the two cylinders 01, 02 and/or a cylinder 01, 02 and the inking system 13 (possibly also the dampening unit 14) can also be provided via toothed belts (possibly by taking the reversal of the direction of rotation into account), or other positively connected drive connections.

The mode of functioning of the drive system of a printing group is as follows:

In the course of the operation, i.e. in the course of the set-up or production operation, the forme cylinder 01 is driven, and the transfer cylinder 02 is driven by it. At the same time the inking system 13 (possibly also the dampening unit 14) are driven by this drive motor 03. In the course of pivoting the transfer cylinder 02 out or in, the drive motor 03 driving the forme cylinder 01 can remain stationary and in a position for an ideal contact with possibly cooperating pinions 11 and gear wheels 06.

If a correction of the lateral register, i.e. a lateral displacement of the printed image, is required, the forme cylinder 01 is displaced in the axial direction by an amount of ±Delta L, for example by means of a drive arrangement, not represented, and preferably arranged on the side of the forme cylinder 01 opposite the drive system, without the drive motor 03 also needing to be displaced.

In one embodiment, the amount ±Delta L of the displacement is absorbed by the coupling 18, wherein its end facing away from the forme cylinder 01 is fixed in place, in particular fixed in place in respect to the axial direction. The displacement does not cause a simultaneous displacement of the circumferential register.

In another embodiment with a drive motor 03 which is not coaxially arranged in respect to the forme cylinder 01, an axial displacement of the forme cylinder 01 without a simultaneous displacement of the circumferential register is possible by means of straight teeth between the gear wheel 06 and the pinion 11.

A correction by means of an electronic shaft between the cylinders 01, 02, as well as a mechanical readjustment of the circumferential register because of a displacement in the lateral register, can be omitted.

### List of Reference Symbols

01 Cylinder, first, forme cylinder

02 Cylinder, second, transfer cylinder

03 Drive motor

04 Journal (01)

05 Cylinder, third, transfer cylinder, counter-pressure cylinder, satellite cylinder

05 Gear wheel (04)

06 Journal (02)

07 Gear wheel (07)

08 Shaft (03)

09 Gear, reduction gear, planetary gear

10 Pinion

11 Gear wheel (07)

13 Inking system

14 Dampening unit

15 —

16 Gear wheel (04)

17 Gear wheel (13)

18 Coupling, elastic, coupling, expansion coupling, shaft coupling, resilient

19 Gear wheel (21)

20 —

21 Shaft, pinion

22 Coupling, claw coupling

23 Gear wheel (24)

24 Bushing

25 —

26 Gear wheel (07)

27 Gear, reduction gear, planetary gear

Length (18)

Delta L Amount of the length change (18), of the axial displacement (01)

1. A drive system for a printing group, having a first cylinder (01) embodied as a forme cylinder (01), a second cylinder (02) acting together with the forme cylinder (01), and an inking system (13) assigned to the forme cylinder (01), wherein the drive system of the two cylinders acts on the forme cylinder (01), which drives the second cylinder (02) via a drive connection (06, 08, 23, 26), characterized in that the inking system (23) is driven by the second cylinder (02) by means of a drive connection (12, 16, 17).

2. The drive system in accordance with claim 1, characterized in that the second cylinder (02) and a third cylinder (05), which forms a print position with the latter, are embodied without a mechanical drive connection.

3. The drive system in accordance with claim 1, characterized in that the forme cylinder (01) can be driven by a drive motor (03) in a manner mechanically independent from the drive system of another printing group.

4. The drive system in accordance with claim 3, characterized in that the inking system (13) assigned to the forme cylinder (02) is driven by means of the same drive motor (03).

5. The drive system in accordance with claim 1, characterized in that the drive connection (06, 08, 23, 26) between the second cylinder (02) and the forme cylinder (01) is embodied in the form of a gear train (06, 08, 23, 26).

6. The drive system in accordance with claim 5, characterized in that the drive connection (06, 08, 23, 26) has a gear wheel (08, 26), which is connected, fixed against relative rotation, with a journal (07) of the second cylinder (02), and a gear wheel (06, 23), which acts together with the gear wheel (08, 26) and is connected in at least a torsion-proof manner with a journal (04) of the forme cylinder (01).

7. The drive system in accordance with claim 1, characterized in that the drive connection (06, 08, 23, 26) between the forme cylinder (01) and the second cylinder (02) is provided by means of a toothed belt.

8. The drive system in accordance with claim 1, characterized in that the drive connection (12, 16, 17) between the forme cylinder (01) and the second cylinder (02) is provided as a gear train (12, 16, 17).

9. The drive system in accordance with claim 8, characterized in that the drive connection (12, 16, 17) has a gear wheel (12), which is arranged fixed against relative rotation on the journal (07) of the second cylinder (02), a gear wheel (16) acting together with the latter and rotatably seated on a journal (04) of the forme cylinder (01), and a gear wheel (17) of an inking system (13), acting together with the latter.

10. The drive system in accordance with claim 1, characterized in that the drive connection (12, 16, 17) between the second cylinder (02) and the inking system (13) is provided by means of a toothed belt.

11. The drive system in accordance with claim 1, characterized in that a torsion-proof coupling (18), whose length (1) can, however, be changed by an amount (±Delta 1) in the axial direction of the forme cylinder (01), is arranged between the drive motor (03) driving the forme cylinder (01) and the forme cylinder (01).

12. The drive system in accordance with claim 11, characterized in that the coupling (18) is embodied as a shaft coupling (18), which is torsion-proof in the circumferential direction and which is positively connected in the axial direction, but is resilient.

13. The drive system in accordance with claim 1, characterized in that the forme cylinder (01) can be driven by means of a drive motor (03) via a gear (10, 27).

14. The drive system in accordance with claim 1, characterized in that a shaft (09) of a drive motor (03) driving the forme cylinder (01) is arranged parallel with and offset in relation to an axis of rotation of the forme cylinder (01).

15. The drive system in accordance with claim 1, characterized in that a shaft (09) of a drive motor (03) driving the forme cylinder (01) is arranged parallel with and coaxial in relation to an axis of rotation of the forme cylinder (01).

16. The drive system in accordance with claim 11 and 15, characterized in that the shaft (09) of the drive motor (03), or its extension, is arranged, fixed against relative rotation, on the side of the coupling (18) facing away from the forme cylinder (01).

17. The drive system in accordance with claim 11, characterized in that a shaft (21) is arranged, fixed against relative rotation and extending coaxially and parallel with an axis of rotation of the forme cylinder (01), on the side of the coupling (18) facing away from the forme cylinder (01).

18. The drive system in accordance with claim 17, characterized in that a gear wheel (19), which is arranged fixed against relative rotation on the shaft (21), meshes with a pinion (11) of a drive motor (03).

19. The drive system in accordance with claim 18, characterized in that the gear wheel (19) and the pinion (11) have helical teeth on their circumference.

20. The drive system in accordance with claim 1, characterized in that a planetary gear is arranged between a drive motor (03) driving the forme cylinder (01) and the forme cylinder (01).

21. The drive system in accordance with claim 1, characterized in that a drive motor (03) driving the forme cylinder (01) has a gear-reducing adapter gear.

22. The drive system in accordance with claim 1, characterized in that the second cylinder (02) is embodied as a transfer cylinder (02).

23. The drive system in accordance with claim 1, characterized in that the second cylinder (02) is embodied as a counter-pressure cylinder (02).
